(19) United States
(12) Patent Application Publication
(10) Pub. No.: US 2025/0237596 A1
(43) Pub. Date: Jul. 24, 2025

(54) PARTICLE SORTING SYSTEM AND PARTICLE SORTING METHOD

(71) Applicant: SONY GROUP CORPORATION, TOKYO (JP)

(72) Inventor: ISAO HIDAKA, TOKYO (JP)

(21) Appl. No.: 18/848,261

(22) PCT Filed: Mar. 20, 2023
(86) PCT No.: PCT/JP2023/010880

§ 371 Date: Sep. 18, 2024

(30) Foreign Application Priority Data
Mar. 29, 2022 (JP) 2022-053949

(51) Int. Cl. G01N 15/1492; G01N 15/14

(52) U.S. Cl. CPC G01N 15/1492; G01N 15/1425; G01N 15/1459

(57) ABSTRACT

To provide a technology for improving accuracy in a technology for sorting particles contained in a fluid. Provided is a particle sorting system including: a first detection unit that detects light from particles contained in a fluid; a vibration element that forms a droplet containing the particles; a second detection unit that is arranged downstream of the first detection unit and detects light from the particles in a fluid stream containing the droplet; and a sorting control unit that controls sorting of the particles on the basis of a delay time from detection by the first detection unit to formation of the droplet; in which the sorting control unit identifies a parameter used for calculation of the delay time from two or more feature values acquired by the second detection unit using two or more different parameters.

### TECHNICAL FIELD

The present technology relates to a particle sorting system. More specifically, the present invention relates to a particle sorting system and a particle sorting method for sorting particles by optically detecting characteristics of the particles.

### BACKGROUND ART

In recent years, along with development of analytical methods, a method is being developed in which biological microparticles such as cells and microorganisms and microparticles such as microbeads and the like are allowed to flow through a flow path, and the particles and the like are individually detected and the detected particles and the like are analyzed or detected in the step of allowing the flow.

As a representative example of such a method of analyzing or sorting the particles, technological improvement of an analytical method referred to as flow cytometry is advancing rapidly. Flow cytometry is an analytical method of analyzing and sorting the particles by allowing the particles to be analyzed to flow in a state arrayed in fluid and applying laser light and the like to the particles to detect fluorescence and scattered light emitted from each of the particles.

For example, in a case of detecting fluorescence of a cell, excitation light having an appropriate wavelength and intensity, such as laser light, is irradiated to a cell labeled with a fluorescent dye. Then, fluorescence emitted from the fluorescent dye is collected by a lens or the like, light having an appropriate wavelength region is selected with use of a wavelength selection element such as a filter or a dichroic mirror, and the selected light is detected with use of a light receiving element such as a photo multiplier tube (PMT). At this time, it is also possible to simultaneously detect and analyze fluorescence from a plurality of fluorescent dyes labeled on a cell, by combining a plurality of wavelength selection elements and light receiving elements. Moreover, it is also possible to increase the number of fluorescent dyes that can be analyzed, by combining excitation light of plural wavelengths.

For fluorescence detection in flow cytometry, in addition to a method of selecting a plurality of lights having discontinuous wavelength regions with use of a wavelength selection element such as a filter and measuring intensity of light in each wavelength region, there is also a method of measuring intensity of light in a continuous wavelength region as a fluorescence spectrum. In spectral flow cytometry capable of measuring a fluorescence spectrum, fluorescence emitted from a particle is dispersed with use of a spectroscopic element such as a prism or a grating. Then, the dispersed fluorescence is detected using a light receiving element array in which a plurality of light receiving elements of different detection wavelength regions is arranged. For the light receiving element array, there is used a PMT array or a photodiode array in which light receiving elements such as PMTs and photodiodes are arranged one dimensionally, or a CCD, a CMOS, or the like in which a plurality of independent detection channels such as two-dimensional light receiving elements are arranged.

In analysis of particles represented by flow cytometry and the like, there are often used an optical method of irradiating a particle to be analyzed with light such as laser, and detecting fluorescence or scattered light emitted from the particle. Then, on the basis of the detected optical information, a histogram is extracted by an analysis computer and software, and analysis is performed.

For example, Patent Document 1 proposes a device for sorting biological particles contained in a liquid flow, the device including: an optical mechanism that irradiates each of biological particles with light to detect light from the biological particles; a control unit that detects a movement speed of the biological particles in the liquid flow on the basis of the light from each of the biological particles; and a charging unit that imparts charge to the biological particles on the basis of the movement speed of each of the biological particles.

### CITATION LIST

### Patent Document

Patent Document 1: Japanese Patent Application Laid-Open No. 2009-145213

### SUMMARY OF THE INVENTION

### Problems to be Solved by the Invention

A main object of the present invention is to provide a technology for improving accuracy in a technology for sorting particles contained in a fluid.

### Solutions to Problems

In the present technology, first, there is provided a particle sorting system including:
a first detection unit that detects light from particles contained in a fluid;
a vibration element that forms a droplet containing the particles;
a second detection unit that is arranged downstream of the first detection unit and detects light from the particles in a fluid stream containing the droplet; and
a sorting control unit that controls sorting of the particles on the basis of a delay time from detection by the first detection unit to formation of the droplet; in which
the sorting control unit identifies a parameter used for calculation of the delay time from two or more feature values acquired by the second detection unit using two or more different parameters.

In the present technology, the feature value can be a value measured at two or more different particle velocities.

At this time, the feature value may be a value identified on the basis of the fluid stream image acquired by the second detection unit.

Then, the feature value may be a value related to a position of a particle in the fluid stream image.

In this case, the sorting control unit can identify a parameter used for calculation of the delay time from a correspondence relationship between a value related to a position of the particle at each particle velocity and each parameter.

In addition, the sorting control unit can identify a parameter used for identifying the delay time from a value related to a deviation width of a position of a particle in the fluid stream image at each particle velocity.

In the present technology, the feature value may be a luminance value of a particle in the fluid stream image.

In this case, the sorting control unit can identify a parameter used for identifying the delay time from a sum of luminance values of particles in the fluid stream image at each particle velocity at an arbitrary position.

A particle sorting system according to the present technology includes
a light irradiation unit that irradiates the particles with excitation light, and
an excitation light detection unit that includes an imaging element that detects the excitation light with which the particles are irradiated.

At this time, the light irradiation unit may be configured to emit a plurality of excitation lights having different wavelengths at different positions in a flow direction of the fluid, and
the excitation light detection unit can detect position information of the plurality of excitation lights.

In this case, the sorting control unit can identify an interval between the plurality of excitation lights on the basis of position information detected by the excitation light detection unit.

Furthermore, the sorting control unit can determine a velocity of the particles on the basis of an interval between the plurality of excitation lights and a detection timing at which the particles are detected by the first detection unit.

In the present technology, next, there is provided a particle sorting method including:
a first detection step of detecting light from particles contained in a fluid;
a droplet formation step of forming a droplet containing the particles;
a second detection step of detecting light from the particles in a fluid stream containing the droplet downstream of the first detection step; and
a sorting control step of controlling sorting of the particles on a basis of a delay time from detection in the first detection step to formation of the droplet, and
identifying a parameter used for calculation of the delay time from two or more feature values acquired in the second detection step using two or more different parameters.

In the present technology, “particles” broadly include: bio-related microparticles such as cells, microorganisms, and ribosomes; synthetic particles such as latex particles, gel particles, and industrial particles; and the like.

The bio-related microparticles include chromosomes forming various cells, ribosomes, mitochondria, organelles (cell organelles) and the like. The cells include animal cells (e.g., hemocyte cells and the like) and plant cells. The microorganisms include bacteria such as Escherichia coli, viruses such as tobacco mosaic virus, fungi such as yeast, and the like. Moreover, the bio-related microparticles may also include bio-related polymers such as nucleic acids, proteins, and composites of these. Furthermore, the industrial particles may be, for example, an organic or inorganic polymer material, a metal, or the like. The organic polymer material includes polystyrene, styrene/divinylbenzene, polymethyl methacrylate, and the like. The inorganic polymer material includes glass, silica, a magnetic material, and the like. The metal includes gold colloid, aluminum, and the like. In general, shapes of these particles are normally spherical, but may be non-spherical in the present technology, while the size, mass, and the like thereof are also not particularly limited.

### BRIEF DESCRIPTION OF DRAWINGS

FIG. 1 is a schematic conceptual diagram schematically illustrating a first embodiment of a particle sorting system 1 according to the present technology.

FIG. 2 is a schematic conceptual diagram schematically illustrating a second embodiment of the particle sorting system 1 according to the present technology.

FIG. 3 is a schematic conceptual diagram schematically illustrating a third embodiment of the particle sorting system 1 according to the present technology.

FIG. 4 is a schematic conceptual diagram illustrating an installation example of a vibration element V and a charging unit 105a.

FIG. 5 is a diagram for describing a control method performed by a sorting control unit 103.

FIG. 6 is a diagram for describing a general delay time calculation method.

FIG. 7 is a drawing-substitute photograph illustrating an example of an image acquired by a second detection unit 102.

FIG. 8 is a diagram for describing a sorting control method according to the first embodiment performed by the sorting control unit 103.

FIG. 9 is a diagram for explaining an example of a method of adjusting a parameter b.

FIG. 10 is a flowchart of a sorting control method according to the first embodiment performed by the sorting control unit 103.

FIG. 11 is a diagram for describing a sorting control method according to the second embodiment performed by the sorting control unit 103.

FIG. 12 is a flowchart of a sorting control method according to the second embodiment performed by the sorting control unit 103.

FIG. 13 is a diagram for describing an example of a method of identifying a parameter a in the sorting control method according to the second embodiment performed by the sorting control unit 103.

FIG. 14 is a diagram for describing a sorting control method according to a third embodiment performed by the sorting control unit 103.

FIG. 15 is a flowchart of the sorting control method according to the third embodiment performed by the sorting control unit 103.

FIG. 16 is a diagram for describing an example of a method of identifying a parameter a in the sorting control method according to the third embodiment performed by the sorting control unit 103.

### MODE FOR CARRYING OUT THE INVENTION

Preferred embodiments for implementing the present technology will be described below with reference to the drawings. The embodiments to be described below are intended to illustrate examples of representative embodiments of the present technology, and the scope of the present technology will not be construed narrower by these embodiments. Note that the description is given in the following order.
1. Particle sorting system 1
(1) Flow path P
(2) Light irradiation unit 104
(3) First detection unit 101
(4) Vibration element V
(5) Second detection unit 102
(6) Excitation light detection unit 106
(7) Sorting unit 105
(8) Sorting control unit 103
(9) Excitation light control unit 107
(10) Light irradiation abnormality detection unit 108
(11) Storage unit 109
(12) Display unit 110
(13) User interface 111
2. Particle sorting method

### 1. Particle Sorting System 1

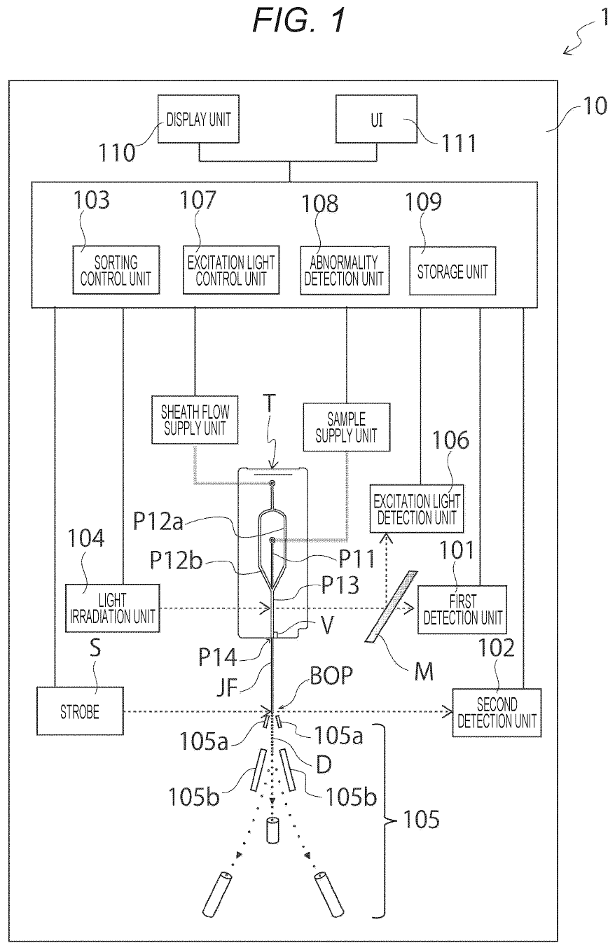

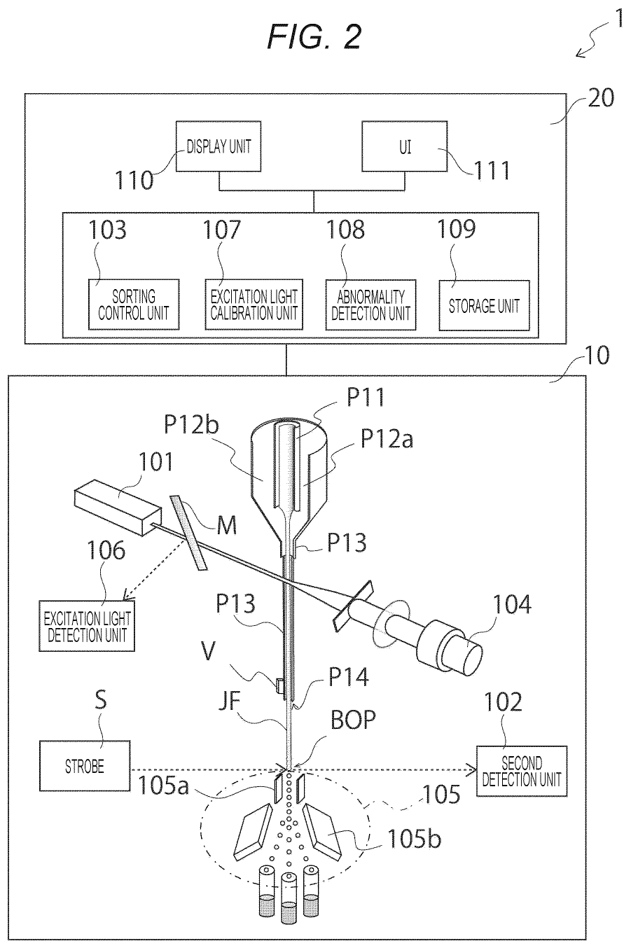

FIG. 1 is a schematic conceptual diagram schematically illustrating a first embodiment of a particle sorting system 1 according to the present technology. FIG. 2 is a schematic conceptual diagram schematically illustrating a second embodiment of a particle sorting system 1 according to the present technology. The particle sorting system 1 according to the present technology includes at least a first detection unit 101, a vibration element V, a second detection unit 102, and a sorting control unit 103. Furthermore, flow paths P (P11 to P13), a light irradiation unit 104, a sorting unit 105, an excitation light detection unit 106, an excitation light control unit 107, a light irradiation abnormality detection unit 108, a storage unit 109, a display unit 110, a user interface 111, and the like can be provided as necessary. Hereinafter, details of each unit will be described.

Note that the sorting control unit 103, the excitation light control unit 107, the light irradiation abnormality detection unit 108, the storage unit 109, the display unit 110, the user interface 111, and the like may be provided in a device 10 that sorts particles as in the first embodiment illustrated in FIG. 1, or may be the particle sorting system 1 including a particle sorting device 10 including a light irradiation unit 104, a first detection unit 101, an excitation light detection unit 106, a vibration element V, and a sorting unit 105, and an information processing device 20 including a sorting control unit 103, an excitation light control unit 107, a light irradiation abnormality detection unit 108, a storage unit 109, a display unit 110, and a user interface 111 as in the second embodiment illustrated in FIG. 2.

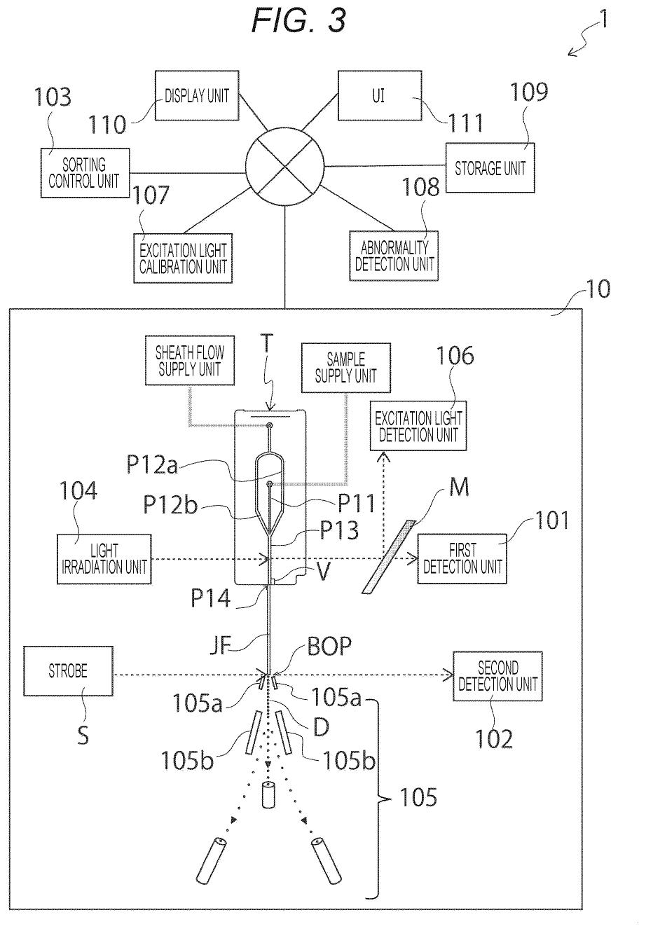

Further, as in a third embodiment of the particle sorting system 1 illustrated in FIG. 3, a sorting control unit 103, the excitation light control unit 107, the light irradiation abnormality detection unit 108, the storage unit 109, the display unit 110, and the user interface 111 may be provided independently of one another, and may be connected to a particle sorting system 1 via a network.

In addition, although not illustrated, the sorting control unit 103, the excitation light control unit 107, the light irradiation abnormality detection unit 108, the excitation light control unit 107, the storage unit 109, and the display unit 110 may be provided in a cloud environment and connected to the particle sorting system 1 via a network. Although not illustrated, it is also possible to provide the sorting control unit 103, the excitation light control unit 107, the light irradiation abnormality detection unit 108, the display unit 110, and the user interface 111 in an information processing device 20, provide the storage unit 109 in a cloud environment, and connect to a particle sorting device 10 and an information processing device 20 via a network. In this case, a record of various processing in the information processing device 20 and the like may be stored in the storage unit 109 on the cloud, and various types of information stored in the storage unit 109 may be shared by a plurality of users.

### (1) Flow Path P

The particle sorting system 1 according to the present technology can analyze and sort particles by detecting optical information obtained from particles aligned in one line in a flow cell (flow path P).

While the flow path P may be provided in advance in the particle sorting system 1, analysis or sorting may also be performed by installing a commercially available flow path P or a disposable chip or the like provided with the flow path P.

The form of the flow path P is not especially limited, and can be freely designed. For example, the flow path is not limited to the flow path P formed in a two-dimensional or three-dimensional plastic or glass substrate T as illustrated in FIGS. 1 and 3, and as illustrated in FIG. 2 to be described later, a flow path P used in a conventional flow cytometer can also be applied to the particle sorting system 1.

Furthermore, the flow path width, the flow path depth, and the flow path cross-sectional shape of the flow path P are not especially limited as long as a laminar flow can be formed, and can be freely designed. For example, a micro flow path having a flow path width of 1 mm or less can also be used in the particle sorting system 1. In particular, a micro flow path having a flow path width of 10 μm or more and 1 mm or less can be suitably used in the present technology.

The method of feeding particles is not particularly limited, and the particles can flow in the flow path P according to the form of the used flow path P. For example, a case of the flow path P formed in the substrate T illustrated in FIGS. 1 and 3 will be described. A sample liquid containing particles is introduced into a sample liquid flow path P11, and a sheath liquid is introduced into two sheath liquid flow paths P12a and P12b. The sample liquid flow path P11 and the sheath liquid flow paths P12a and P12b merge to form a main flow path P13. A sample liquid laminar flow fed in the sample liquid flow path P11 and sheath liquid laminar flows fed in the sheath liquid flow paths P12a and P12b can merge in the main flow path P13 to form a sheath flow in which the sample liquid laminar flow is sandwiched between the sheath liquid laminar flows.

The particles that flow through the flow path P can be labeled with one or two or more dyes such as fluorescent dyes. In this case, the fluorescent dyes available in the present technology include, for example, Cascade Blue, Pacific Blue, fluorescein isothiocyanate (FITC), phycoerythrin (PE), propidium iodide (PI), Texas Red (TR), peridinin chlorophyll protein (PerCP), allophycocyanin (APC), 4′,6-diamidino-2-phenylindole (DAPI), Cy3, Cy5, Cy7, Brilliant Violet (BV421) and the like.

### (2) Light Irradiation Unit 104

The light irradiation unit 104 irradiates particles contained in a fluid with excitation light. The light irradiation unit 104 may be provided with a plurality of light sources so that excitation light having different wavelengths can be irradiated. In this case, a plurality of excitation lights having different wavelengths can be emitted at different positions in the flow direction of the fluid.

The type of light emitted from the light irradiation unit 104 is not particularly limited, but light having a constant light direction, wavelength, and light intensity is desirable in order to reliably generate fluorescence or scattered light from particles. A laser, an LED, and the like may be used, for example. In the case of using a laser, the type of laser is not particularly limited, and it is possible to freely combine and use one or two or more of an argon ion (Ar) laser, a helium-neon (He—Ne) laser, a dye laser, a krypton (Cr) laser, a semiconductor laser, a solid-state laser obtained by combining the semiconductor laser and a wavelength conversion optical element or the like.

### (3) First Detection Unit 101

The first detection unit 101 detects light from particles contained in a fluid. Specifically, by irradiation of excitation light, fluorescence or scattered light emitted from the particles is detected and converted into an electric signal.

As long as the light detection unit used for the first detection unit 101 in the present technology can detect light from the particles, the specific light detection method is not particularly limited, and it is possible to freely select and adopt the light detection method used in the well-known light detection unit. For example, it is possible to freely combine and adopt one or two or more of the light detection methods used in a fluorescence measuring instrument, a scattered light measuring instrument, a transmitted light measuring instrument, a reflected light measuring instrument, a diffracted light measuring instrument, an ultraviolet spectroscopic measuring instrument, an infrared spectroscopic measuring instrument, a Raman spectroscopic measuring instrument, a FRET measuring instrument, a FISH measuring instrument and other various spectrum measuring instruments, a PMT array or a photodiode array in which light receiving elements such as PMTs and photodiodes are one-dimensionally arranged, those in which a plurality of independent detection channels such as two-dimensional light receiving elements such as CCD or CMOS is arranged, or the like.

### (4) Vibration Element V

In the particle sorting system 1 according to the present technology, droplets containing particles are formed by the vibration element V. Specifically, when fluid containing particles is ejected as a jet flow JF from an orifice P14 of the flow path P13, the horizontal cross section of the jet flow JF is modulated in synchronization with the frequency of the vibration element V along the vertical direction by applying vibration to the whole or a part of the main flow path P13 using the vibration element V vibrating at a predetermined frequency, and droplets D are separated and generated at a break-off point BOP.

Note that the vibration element V used in the present technology is not particularly limited, and a vibration element V that can be used in a particle sorting device such as a general flow cytometer can be freely selected and used. A piezo vibration element and the like may be used, for example. Furthermore, by adjusting the liquid feeding amount to the sample liquid flow path P11, the sheath liquid flow paths P12a and P12b, and the main flow path P13, the diameter of the discharge port, the vibration frequency of the vibration element, and the like, it is possible to adjust the size of the droplets D and generate the droplets D containing a constant amount of particles.

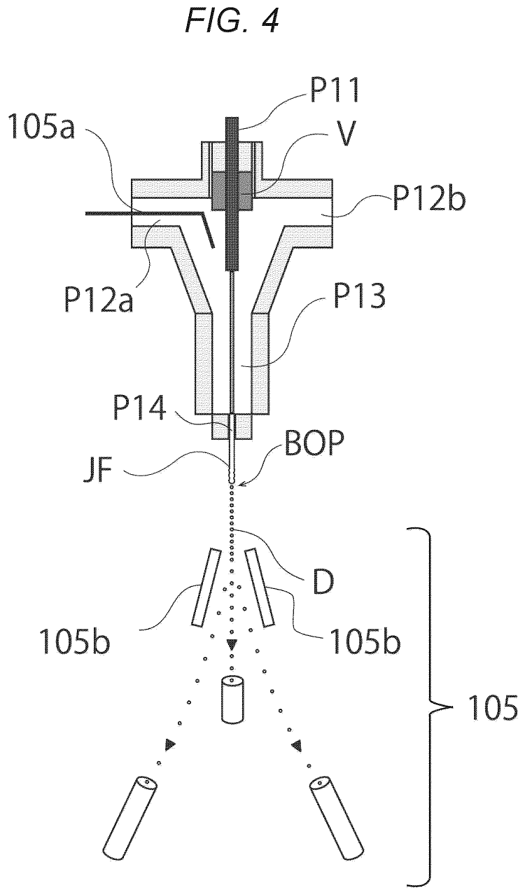

In the present technology, the position of the vibration element V is not particularly limited, and the vibration element V can be freely arranged as long as the droplets containing the particles can be formed. For example, as illustrated in FIGS. 1 to 3, the vibration element V can be arranged in the vicinity of the orifice P14 of the main flow path P13, or as illustrated in FIG. 4, the vibration element V can be arranged upstream of the flow path P to apply vibration to the entire or a part of the flow path P or the sheath flow inside the flow path P.

### (5) Second Detection Unit 102

The second detection unit 102 detects light from the particles in a fluid stream containing droplets (hereinafter also referred to as “the fluid stream”). Moreover, the second detection unit 102 is arranged downstream of the first detection unit 101.

The specific configuration of the second detection unit 102 is not limited as long as it can detect light from the particles in the fluid stream. For example, the configuration is not limited to a configuration including an imaging element such as a CCD camera or a CMOS sensor, and the configuration may be a so-called line sensor or the like in which a plurality of sensors capable of detecting luminance information of light such as a light amount sensor is arranged.

The second detection unit 102 is arranged at a position where light from the particles in the fluid stream can be detected between the orifice P14 and deflection plates 13a and 13b to be described later.

The light information and the image obtained by the second detection unit 102 are displayed on the display unit 110 such as a display to be described later, and can also be used by the user to confirm the formation status of droplets and particle information (size, form, interval, and the like) in the fluid stream.

As a light source for detecting light from the particles in the fluid stream in the second detection unit 102, a strobe S can be used, for example. The strobe S can also be controlled by the sorting control unit 103 to be described later. The strobe S can include an LED for detecting the fluid stream and a laser (e.g., red laser light source) for detecting particles, and a light source to be used can be switched according to the purpose of detection by the sorting control unit 103. The specific structure of the strobe S is not particularly limited, and one or two or more well-known circuits or elements can be selected and freely combined.

### (6) Excitation Light Detection Unit 106

The particle sorting system according to the present technology can include the excitation light detection unit 106. The excitation light detection unit 106 is characterized by including an imaging element. The imaging element captures an image of a state of excitation light with which particles are irradiated.

In the present technology, the excitation light detection unit 106 is not essential. However, the actual position of the excitation light on the objective lens focal plane is affected by heat generated by the light irradiation unit 104 or the particle sorting system 1 itself, and may vary with time. Therefore, by providing the excitation light detection unit 106, it is possible to detect the state of the excitation light with which the particles are irradiated, and thus, it is possible to capture a temporal variation of the excitation light, and as a result, it is possible to contribute to improvement of detection accuracy and sorting accuracy.

Specifically, while the excitation light interval is about 1 mm or less under the restriction of the lens field of view, the distance from the first detection unit 101 to the break-off point BOP is about several tens of millimeters. Therefore, even in a case where a slight change occurs in the excitation light interval, the slight change has a large influence on the identification of the delay time as an error of several tens of times that amount. Under such circumstances, speed compensation by the conventional method requires very high stability of excitation light (pointing stability), and it has been difficult to secure stability as a sorting system.

Therefore, in the present technology, since the initial value and the temporal change of the excitation light interval can be measured with high accuracy by installing the excitation light detection unit 106, a system is constructed in which the measured initial value and temporal change of the excitation light interval are reflected in delay time calculation in the sorting control unit 103 to be described later, thereby achieving highly accurate delay time management. As a result, it is possible to improve robustness of delay time management corresponding to individual particle velocities and to achieve stable sorting performance.

Note that in addition to an imaging device such as a CCD or a CMOS camera, various imaging elements such as a photoelectric conversion element can be used for imaging the excitation light. Furthermore, although not illustrated, the imaging element may be provided with a movement mechanism for changing the position thereof. Moreover, the particle sorting system 1 of the present embodiment may also be provided with a light source (not illustrated) that illuminates an imaging region in addition to the imaging element.

Furthermore, for example, in the case where fluorescence is detected in the first detection unit 101, the excitation light detection unit 106 may totally reflect the excitation light to the side of the excitation light detection unit 106 using a dichroic mirror M or the like. In addition, the excitation light detection unit 106 can be implemented by totally reflecting a mirror such as a half mirror at a constant ratio or a range (e.g., the same NA as that of the excitation light) that does not affect scattered light or the like detected by the first detection unit 101 on the first detection unit 101 side facing the light irradiation unit 104. Alternatively, although not illustrated, it is also possible to implement the excitation light detection unit 106 by imaging the excitation light by installing a low reflection mirror in front of the objective lens.

In a case where the light irradiation unit 104 emits a plurality of excitation lights having different wavelengths at different positions in the flow direction of the fluid, the excitation light detection unit 106 can detect position information of the plurality of excitation lights.

The excitation light detection unit 106 can also detect the intensity of the excitation light. Specifically, the excitation light detection unit 106 can detect the intensity distribution of the excitation light: the intensity distribution of the short axis, the intensity distribution of the long axis, and the like in real time. In addition, the excitation light detection unit 106 can also detect the shape of the excitation light: width, length, inclination, and the like in real time. Furthermore, the excitation light detection unit 106 can detect the relative position and the absolute position of the excitation light in real time.

The particle sorting system 1 according to the present technology can also grasp the condition of the device by recording the temporal variation of the excitation light information detected by the excitation light detection unit 106 for each time, each day, or the like.

Furthermore, in a case where the intensity of the excitation light is different for each excitation wavelength or the sensitivity of the imaging element is different for each excitation wavelength, it is possible to grasp an accurate excitation light state by switching an image of the excitation light to a camera gain suitable for each excitation light and performing imaging a plurality of times. At this time, since correct detection cannot be performed when an image is over-exposed or under-exposed, it is necessary to contrive imaging a plurality of times with a camera gain suitable for each excitation light.

By providing the excitation light detection unit 106 having the above function, it is possible to detect an abnormality of the device. In addition, since the abnormal state can be grasped in real time, readjustment of the excitation light can be performed automatically or remotely.

In addition, since the optical signal intensity detected by the first detection unit 101 depends on the excitation light intensity, it is possible to manage the optical signal intensity as a quantitative optical signal intensity by detecting the intensity of the excitation light.

Furthermore, the optical signal detected by the first detection unit 101 can be corrected according to a change in intensity of the excitation light. As a result, the photodetection accuracy can be improved.

### (7) Sorting Unit 105

In the sorting unit 105, the droplets D containing the particles formed by the vibration element V are sorted. Specifically, the droplet D is charged with positive or negative charge on the basis of the analysis result of the size, form, internal structure, and the like of the particles analyzed from the optical signal detected by the first detection unit 101 (see reference numeral 105a). Then, the charged droplet D, whose path is changed to a desired direction by a counter electrode 105b applied with a voltage, is sorted.

In the present technology, the position of the charging unit 105a is not particularly limited, and can be freely arranged as long as the droplet D including the particles can be charged. For example, as illustrated in FIGS. 1 to 3, the droplet D can be directly charged at the downstream of the break-off point BOP, or as illustrated in FIG. 4, the charging unit 105a including an electrode or the like can be arranged in the sheath liquid flow path P12a or P12b, and the droplet D containing target particles can be charged via the sheath liquid immediately before the formation of the droplet D.

### (8) Sorting Control Unit 103

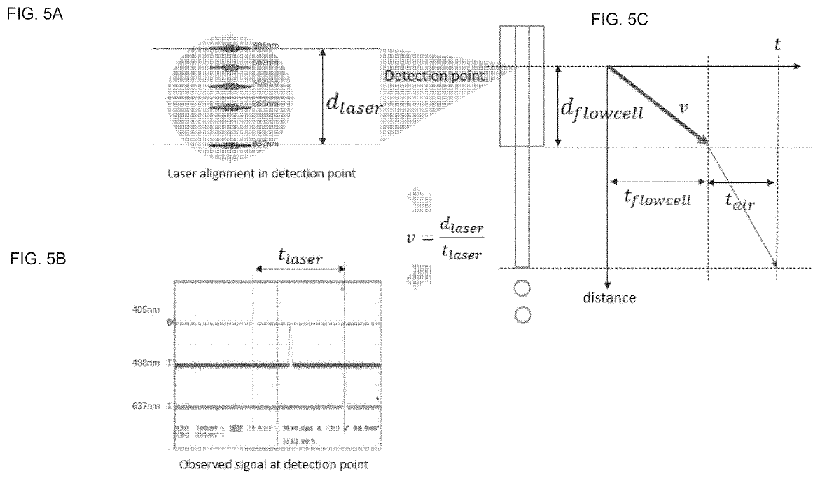

The sorting control unit 103 controls the sorting of the particles on the basis of the delay time from the detection by the first detection unit 101 to the formation of the droplets. In addition, the sorting control unit 103 identifies a parameter to be used for calculation of the delay time from two or more feature values acquired by the second detection unit 102 using two or more different parameters. Hereinafter, details of the control method performed by the sorting control unit 103 will be described with reference to FIG. 5.

The delay time is obtained by adding the passing time (passing time of flow cell) t_{flowcell} from the excitation light irradiation to the orifice P14 and the passing time tₐᵢᵣ in the space after the orifice P14 is discharged (see FIG. 5C). Here, t_{flowcell} can be expressed by a distance d_{flowcell} from the excitation light irradiation to the orifice P14 and a velocity v of the particles in the flow cell (see following formula (1)).

$$\begin{matrix}[ Math . 1 ] & \\ {t}_{flowcell} = {d}_{flowcell} / v & ( 1 )\end{matrix}$$

The velocity v can be detected by the first detection unit 101. Specifically, the velocity v can be obtained from an excitation light distance dₗₐₛₑᵣ (see FIG. 5A) and a passing time tₗₐₛₑᵣ between excitation lights of individual particles (see following formula (2)).

$$\begin{matrix}[ Math . 2 ] & \\ v = {d}_{laser} / {t}_{laser} & ( 2 )\end{matrix}$$

As described above, a delay time t can be expressed by the following formula (3).

$$\begin{matrix}[ Math . 3 ] & \\ t = ( {d}_{flowcell} / {d}_{laser} ) \times {t}_{laser} + {t}_{air} & ( 3 )\end{matrix}$$

Here, although there are design values for the distance d_{flowcell} from the excitation light irradiation to the orifice P14 and the distance dₗₐₛₑᵣ between the excitation lights, the design values cannot be used because the actual values have component tolerances and adjustment errors. Hereinafter, the formula (3) is simplified and expressed by the following formula (4).

$$\begin{matrix}[ Math . 4 ] & \\ {t}_{i} = a \times {t}_{Li} + b & ( 4 )\end{matrix}$$

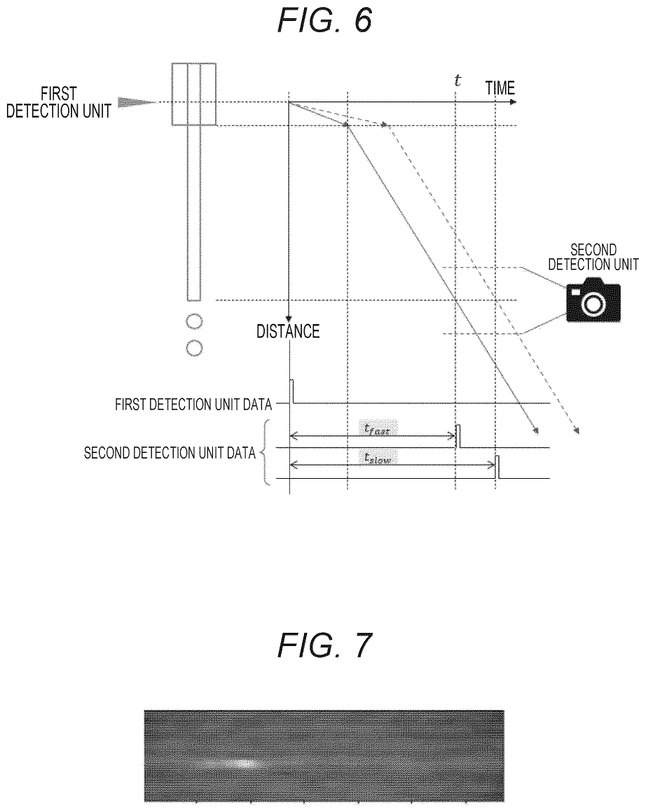

Here, in order to obtain the value of a parameter a, for example, the following method can be used using fast particles and slow particles for observation. In the observation of each of the fast particles and the slow particles, the passing time t_{Li} between the excitation lights is measured, and is denoted as t_{Lfast} and t_{Lslow}, respectively. Furthermore, at the time of each observation, the delay time is adjusted so that the particle emits light on the second detection unit 102, and light is emitted at the position of the break-off point BOP. The delay times at this time are denoted as t_{fast} and t_{slow}, respectively (see FIG. 6). From these two observations, the following formulae (5) and (6) are obtained, and by solving them as simultaneous equations, the values of the parameter a and a parameter b can be obtained.

$$\begin{matrix}[ Math . 5 ] & \\ {t}_{fast} = a \times {t}_{Lfast} + b & ( 5 )\end{matrix}$$

$$\begin{matrix}[ Math . 6 ] & \\ {t}_{slow} = a \times {t}_{Lslow} + b & ( 6 )\end{matrix}$$

However, the image acquired by the second detection unit 102 has a width and luminance unevenness as in an example of the image acquired by the second detection unit 102 illustrated in FIG. 7, and it is not possible to determine whether the image is completely located at the position of the break-off point BOP. Therefore, there may be a problem that t_{fast} and t_{slow} cannot be strictly observed.

Therefore, in the present technology, the parameter to be used for calculation of the delay time is identified from two or more feature values acquired by the second detection unit 102 using two or more different parameters, whereby the value of the parameter with higher sorting accuracy can be obtained. Hereinafter, a specific method will be described.

### First Embodiment of Sorting Control Method

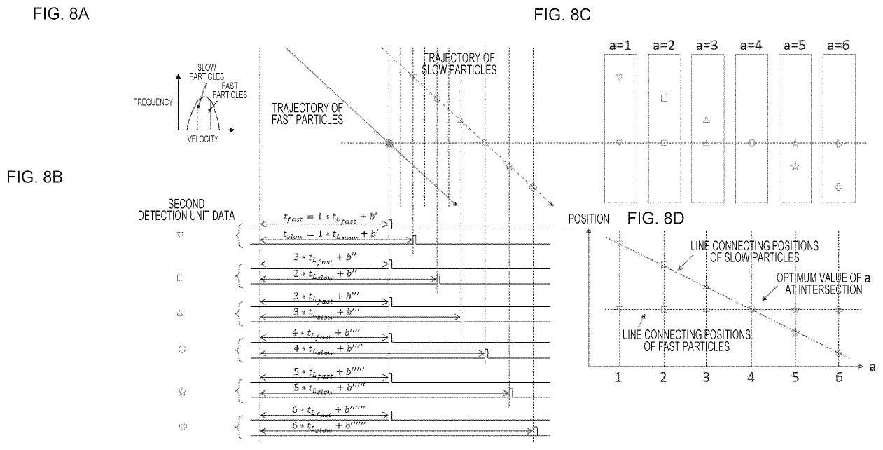

A first embodiment of a sorting control method performed by the sorting control unit 103 will be described with reference to FIG. 8. In the sorting control method according to the first embodiment, parameters to be used for calculating the delay time are identified from two or more feature values acquired by the second detection unit 102 using two or more parameters a. In the sorting control method according to the first embodiment, the parameter a is swept in a range of one to six, and the light from the particles is detected by the second detection unit 102.

In the sorting control method according to the first embodiment, light from particles is detected by the second detection unit 102 at two or more different particle velocities of particles with a high particle velocity and particles with a low particle velocity. FIG. 8A illustrates a trajectory of particles having a high particle velocity and particles having a low particle velocity, and FIG. 8B illustrates a formula (5) and a formula (6) representing delay times when the parameter a is swept in a range of one to six. FIG. 8C illustrates positions of light from particles detected by the second detection unit 102. As illustrated in FIG. 8C, it can be seen that sweeping the parameter a changes the position of light from particles with a slow particle velocity.

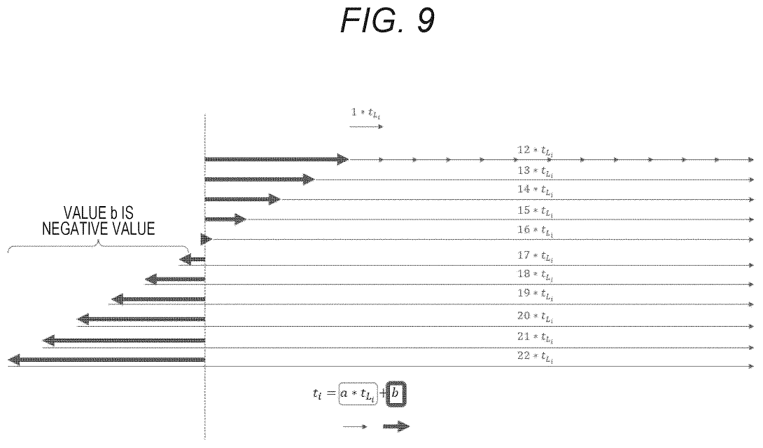

Note that in the example illustrated in FIG. 8, for easy understanding, a parameter b is adjusted so that the detection position of the light from the particles having a high particle velocity is the same regardless of the value of the parameter a, and thus, the detection position of the light from the particles having a high particle velocity in FIG. 8C is the same position at all times when the parameter a is swept in the range of one to six. However, the present invention is not limited thereto. For example, as illustrated in FIG. 9, when the parameter a differs by one, the light emission can be confirmed at substantially the same place by shifting the parameter b by about t_{Li}. Therefore, the parameter b can be adjusted by shifting the parameter b by about tri according to the sweep of the parameter a. Note that the adjustment of the parameter b does not need to be a strict value, and a representative passing time between excitation lights may be used.

Here, FIG. 8D is a graph obtained by reading and plotting the positions of light from particles having a high particle velocity and particles having a low particle velocity from an image acquired by the second detection unit 102. As illustrated in FIG. 8D, the positions of the light from the particles having a high particle velocity and the particles having a low particle velocity are aligned linearly when the parameter a is swept. At this time, a parameter a at which a line indicating the position of light from particles having a high particle velocity and particles having a low particle velocity intersects can be identified as an optimum value.

As described above, in the sorting control method according to the first embodiment, the parameter a used for the calculation of the delay time is identified from the correspondence relationship between the value (i.e., position of light detected from each particle in example of FIG. 8) related to the position of each particle at each particle velocity (fast particle and slow particle) and each parameter (i.e., parameter a swept in range of 1 to 6 in example of FIG. 8).

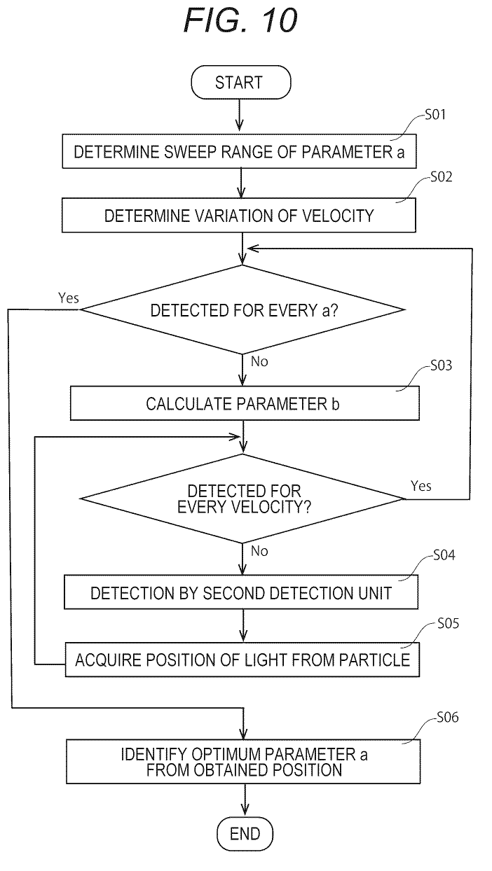

FIG. 10 illustrates a flowchart of the sorting control method according to the first embodiment described above. As illustrated in FIG. 10, in the sorting control method according to the first embodiment, first, a sweep range of the parameter a is determined (S01). An approximate value of the parameter a may be determined from d_{flowcell}/dₗₐₛₑᵣ=a in the above formula (3) using, for example, a design value of the device, and the parameter a may be swept in an arbitrary range such as +5 with respect to this value. Next, variations of the particle velocity are determined (S02). As the particle velocity, at least two or more velocities may be arbitrarily selected, and by selecting many variations of the particle velocity, it is possible to identify a parameter that can calculate the delay time with higher sorting accuracy.

Next, a parameter b corresponding to the parameter a is calculated (S03). The parameter b can be calculated using, for example, the following formula (7).

$$\begin{matrix}[ Math . 7 ] & \\ b = {b}_{base} + ( {a}_{base} - a ) \times {t}_{Lany} & ( 7 )\end{matrix}$$

a_{base}: a calculated from d_{flowcell}/dₗₐₛₑᵣ=a using, for example, the design value of the apparatus
b_{base}: b in which the position of the light from the particle acquired by the second detection unit 102 is substantially the center of the image using a=a_{base}
t_{Lany}: the passing time between excitation lights at an arbitrary velocity

When t_{Lfast} of particles having a high particle velocity is used, the position of light obtained from particles having a high particle velocity is constant.

The second detection unit 102 detects light from particles on the basis of the delay time calculated by the parameter a and the parameter b (S04), and acquires the position of the light (S05). This is repeated until the detection of all the values of the parameter a is completed. For example, when n kinds of “a” and m kinds of velocities are assigned, and the light from the particles is detected by the second detection unit 102, data as shown in Table 1 below can be obtained.

TABLE 1

| x | y₁ | y₂ | . . . | yₘ |
|---|---|---|---|---|
| a₁ | p₁₁ | p₂₁ | . . . | pₘ₁ |
| a₂ | p₁₂ | p₂₂ | . . . | pₘ₂ |
| . . . | . . . | . . . | . . . | . . . |
| aₙ | p₁ₙ | p₂ₙ | . . . | pₘₙ |

x: a
y: position of light acquired from particles at velocity m by second detection unit 102

Here, the pair of x and yᵢ takes the linear form of the following formula (8). That is, m straight lines are formed.

$$\begin{matrix}[ Math . 8 ] & \\ {y}_{i} = {c}_{i} x + {d}_{i} & ( 8 )\end{matrix}$$

$$i : 1 to m$$

Then, cᵢ and dᵢ can be obtained by, for example, the following formulae (9) and (10) by a least squares method. Here, when i=1, a₁ to aₙ in Table 1 are used for xₖ, and p₁₁ to p₁ₙ in Table 1 are used for yₖ.

$$\begin{matrix}[ Math . 9 ] & \\ {c}_{i} = \frac{n {\sum }_{k = 1}^{n} {x}_{k} {y}_{k} - {\sum }_{k = 1}^{n} {x}_{k} {\sum }_{k = 1}^{n} {y}_{k}}{n {\sum }_{k = 1}^{n} {x}_{k}^{2} - {( {\sum }_{k = 1}^{n} {x}_{k} )}^{2}} & ( 9 )\end{matrix}$$

$$\begin{matrix}[ Math . 10 ] & \\ {d}_{i} = \frac{{\sum }_{k = 1}^{n} {x}_{k}^{2} {\sum }_{k = 1}^{n} {y}_{k} - {\sum }_{k = 1}^{n} {x}_{k} {y}_{k} {\sum }_{k = 1}^{n} {x}_{k}}{n {\sum }_{k = 1}^{n} {x}_{k}^{2} - {( {\sum }_{k = 1}^{n} {x}_{k} )}^{2}} & ( 10 )\end{matrix}$$

Then, the optimum parameter a is identified from the intersections of the obtained m straight lines (S06). Specifically, for example, the number of intersections obtained from the m linear expressions is ₘC₂, and the intersections for this number is calculated. The optimum parameter a is obtained from the obtained intersections. As a method of obtaining the optimum parameter a, for example, the parameter a can be obtained from an average, an intermediate value, or the like of all intersections.

### Second Embodiment of Sorting Control

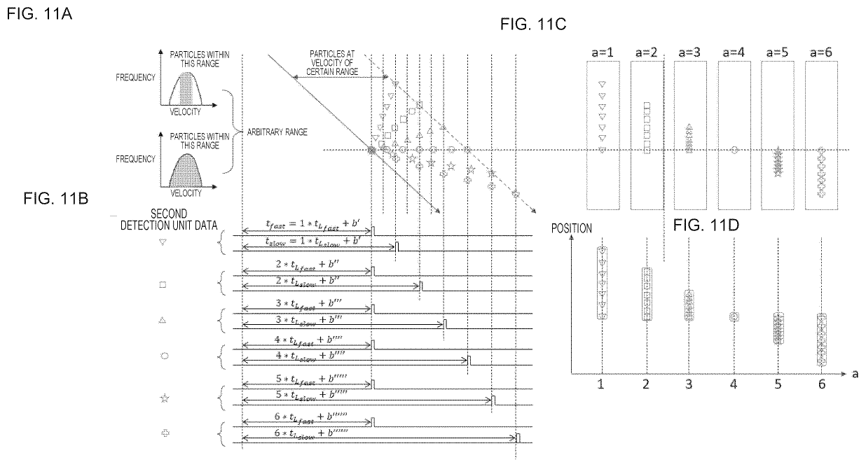

A second embodiment of a sorting control method performed by the sorting control unit 103 will be described with reference to FIG. 11. Also in the sorting control method according to the second embodiment, parameters to be used for calculating the delay time are identified from two or more feature values acquired by the second detection unit 102 using two or more parameters a. Also in the sorting control method according to the second embodiment, the parameter a is swept in a range of one to six, and the light from the particles is detected by the second detection unit 102.

In the sorting control method according to the second embodiment, the second detection unit 102 detects light from particles at a particle velocity in a certain range. FIG. 11A illustrates a trajectory of particles at a particle velocity in a certain range, and FIG. 11B illustrates a formula (5) and a formula (6) representing delay time when the parameter a is swept in a range of one to six. FIG. 11C illustrates positions of light from particles detected by the second detection unit 102. As illustrated in FIG. 11C, it can be seen that a deviation occurs in the position of light from the particles by sweeping the parameter a. Note that, also in the example illustrated in FIG. 11, for easy understanding, a parameter b is adjusted so that the detection position of the light from the particle having the fastest particle velocity is the same regardless of the value of the parameter a, and thus, the detection position of the light from the particle having the fastest particle velocity in FIG. 11C is the same position at all times when the parameter a is swept in the range of one to six. However, the present invention is not limited thereto.

Here, FIG. 11D is a graph obtained by reading and plotting the deviation width of the particle position from an image acquired by the second detection unit 102. As illustrated in FIG. 11D, when the parameter a is swept, it can be seen that the deviation widths of the parameters a are different. At this time, the parameter a having the minimum deviation width can be identified as the optimum value.

As described above, in the sorting control method according to the second embodiment, the parameter a used for the calculation of the delay time is identified from the value (i.e., deviation width of position of light detected from each particle in example of FIG. 11) related to the deviation width of the position of each particle at the particle velocity in a certain range.

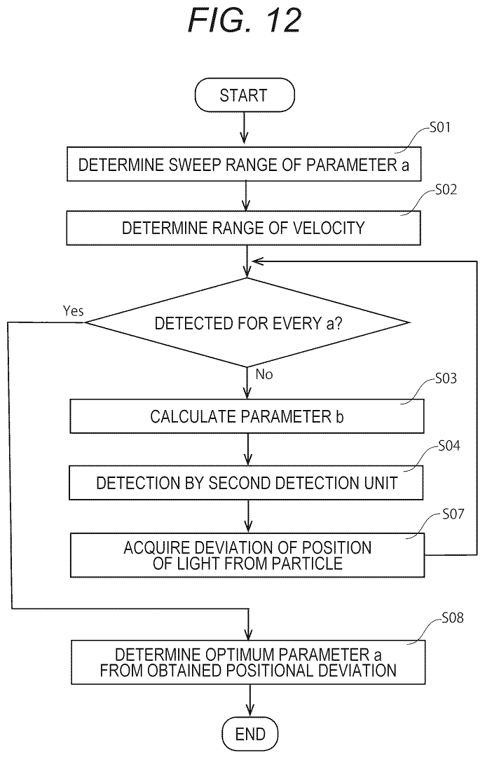

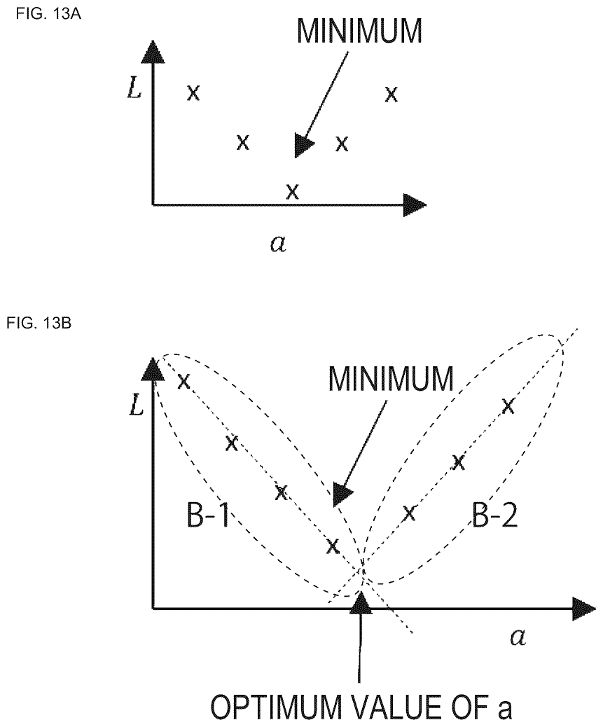

FIG. 12 illustrates a flowchart of the sorting control method according to the second embodiment described above. As illustrated in FIG. 12, in the sorting control method according to the second embodiment, first, a sweep range of the parameter a is determined (S01). Since the method of determining the sweep range of the parameter a is the same as the sorting control method according to the first embodiment, the description thereof will be omitted here. Next, after the range of the particle velocity is determined (S02), the parameter b corresponding to the parameter a is calculated (S03). Since the method of calculating the parameter b is also the same as the sorting control method according to the first embodiment, the description thereof will be omitted here.

Then, on the basis of the delay time calculated by the parameter a and the parameter b, the second detection unit 102 detects light from particles at a particle velocity in a certain range (S04), and acquires a deviation width of the position (S07). This is repeated until the detection of all the values of the parameter a is completed. For example, when n kinds of “a” are assigned and the deviation width of light from the particle is detected by the second detection unit 102 at a particle velocity in a certain range, data as shown in Table 2 below can be obtained.

TABLE 2

| x | y |
|---|---|
| a₁ | L₁ |
| a₂ | L₂ |
| . . . | . . . |
| aₙ | Lₙ |

x: a
y: deviation width of light position acquired from particles at a particle velocity in a certain range by the second detection unit 102

The optimum parameter a is identified from the obtained value of the light deviation width (S08). As the identification method, for example, as in the example illustrated in FIG. 13A, the deviation width of the light obtained for each parameter a can be plotted on a graph, and the parameter a having the minimum deviation width can be identified as the optimum value.

Furthermore, for example, as in the example illustrated in FIG. 13B, the deviation width of light obtained for each parameter a is plotted on a graph, and in the graph, a linear equation is obtained by the least squares method for a straight line including all or some of the pairs of a and L included in B-1 and a straight line including all or some of the pairs of a and L included in B-2 (see the above formulae (8) to (10)), and the optimum parameter a can be identified from the intersection of the straight lines represented by the two linear equations.

### Third Embodiment of Sorting Control

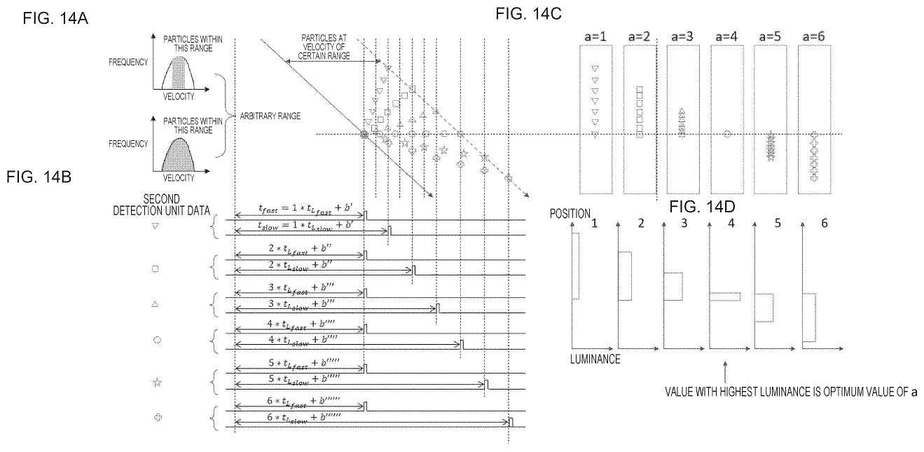

A third embodiment of a sorting control method performed by the sorting control unit 103 will be described with reference to FIG. 14. Also in the sorting control method according to the third embodiment, parameters to be used for calculating the delay time are identified from two or more feature values acquired by the second detection unit 102 using two or more parameters a. In the sorting control method according to the third embodiment, the parameter a is swept in a range of one to six, and the light from the particles is detected by the second detection unit 102.

Also in the sorting control method according to the third embodiment, the second detection unit 102 detects light from particles at a particle velocity in a certain range. FIG. 14A illustrates a trajectory of particles at a particle velocity in a certain range, and FIG. 14B illustrates a formula (5) and a formula (6) representing delay time when the parameter a is swept in a range of one to six. FIG. 14C illustrates positions of light from particles detected by the second detection unit 102. As illustrated in FIG. 14C, it can be seen that a deviation occurs in the position of light from the particles by sweeping the parameter a. Note that, also in the example illustrated in FIG. 14, for easy understanding, a parameter b is adjusted so that the detection position of the light from the particle having the fastest particle velocity is the same regardless of the value of the parameter a, and thus, the detection position of the light from the particle having the fastest particle velocity in FIG. 14C is the same position at all times when the parameter a is swept in the range of one to six. However, the present invention is not limited thereto.

Here, FIG. 14D is a graph obtained by reading and plotting the luminance at each position of the particle from an image acquired by the second detection unit 102. As illustrated in FIG. 14D, when the parameter a is swept, it can be seen that the distribution of luminance in the parameters a are different. That is, as the parameter a approaches the optimum value, the position of the light detected from the particle at the particle velocity in a certain range is concentrated at one point, so that the sum of the luminance values of the light detected from the particle at this position increases. Therefore, the parameter a having the maximum sum of the luminance values at an arbitrary position can be identified as the optimum value.

As described above, in the sorting control method according to the third embodiment, the parameter a used for the calculation of the delay time is identified from the value (i.e., sum of luminance of light detected from particles at arbitrary position in example of FIG. 14) related to the sum of the luminance values of the light obtained from the particles in a fluid stream image at each particle velocity.

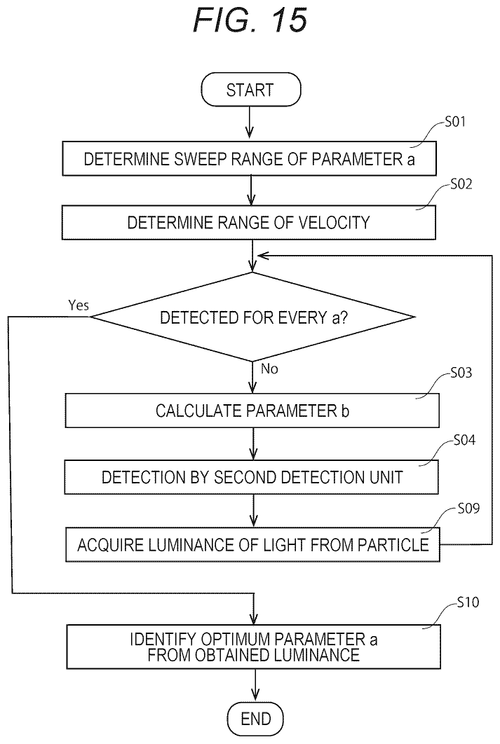

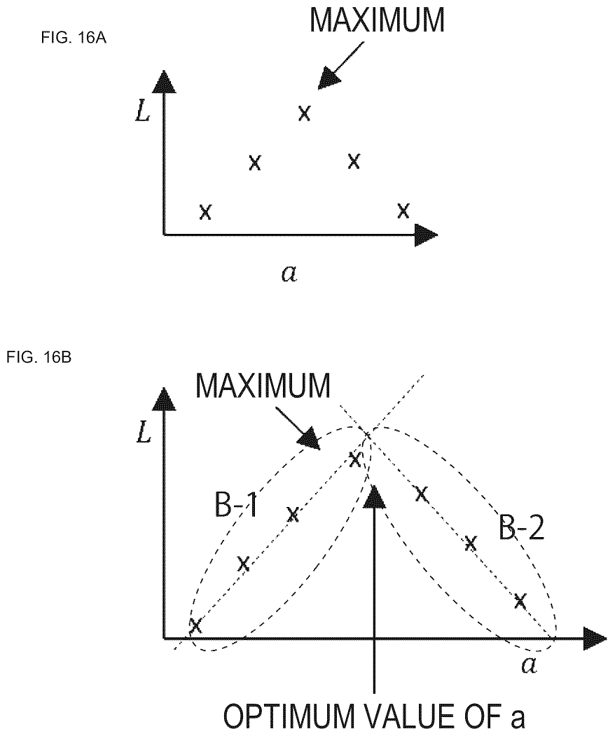

FIG. 15 illustrates a flowchart of the sorting control method according to the third embodiment described above. As illustrated in FIG. 15, in the sorting control method according to the third embodiment, first, a sweep range of the parameter a is determined (S01). Since the method of determining the sweep range of the parameter a is the same as the sorting control method according to the first embodiment, the description thereof will be omitted here. Next, after the range of the particle velocity is determined (S02), the parameter b corresponding to the parameter a is calculated (S03). Since the method of calculating the parameter b is also the same as the sorting control method according to the first embodiment, the description thereof will be omitted here.

Then, on the basis of the delay time calculated by the parameter a and the parameter b, the second detection unit 102 detects light from particles at a particle velocity in a certain range (S04), and acquires a luminance of the light (S09). This is repeated until the detection of all the values of the parameter a is completed. For example, when n kinds of “a” are assigned and the luminance of light from the particles is detected by the second detection unit 102 at a particle velocity in a certain range, data as shown in Table 3 below can be obtained.

TABLE 3

| x | y |
|---|---|
| a₁ | L₁ |
| a₂ | L₂ |
| . . . | . . . |
| aₙ | Lₙ |

x: a
y: luminance of light acquired from particles at a particle velocity in a certain range by the second detection unit 102

The optimum parameter a is identified from the obtained luminance value of light (S10). As the identification method, for example, as in the example illustrated in FIG. 16A, the sum of the luminances of the light obtained in each parameter a is plotted on a graph, and the parameter a having the maximum sum of the luminance values at an arbitrary position can be identified as the optimum value.

Furthermore, for example, as in the example illustrated in FIG. 16B, the luminance of light obtained for each parameter a is plotted on a graph, and in the graph, a linear equation is obtained by the least squares method for a straight line including all or some of the pairs of a and L included in B-1 and a straight line including all or some of the pairs of a and L included in B-2 (see the above formulae (8) to (10)), and the optimum parameter a can be identified from the intersection of the straight lines represented by the two linear equations.

When the parameter used to calculate the delay time is identified, a droplet may be generated using the vibration element V, and light from particles contained in the droplet may be detected by the second detection unit 102, or light from particles contained in the fluid stream may be detected by the second detection unit 102 without generating a droplet, and the parameter used to calculate the delay time can be identified from the detected feature value.

### <Other Functions of Sorting Control Unit 103>

The sorting control unit 103 can identify an interval between the plurality of excitation lights on the basis of the position information detected by the excitation light detection unit 106. By identifying the interval between the plurality of excitation lights, it is possible to improve the accuracy of light detection in the first detection unit 101.

In addition, the sorting control unit 103 can identify an interval between the plurality of excitation lights on the basis of the position information detected by the excitation light detection unit 106, and can identify a delay time from irradiation of the excitation light to the particle to formation of the droplet containing the particle on the basis of the identified interval between the plurality of excitation lights.

For example, in Patent Document 1 described above, the moving speed of the particle is obtained on the basis of the excitation light spot interval, and the charging timing to the droplet D containing the particle is controlled on the basis of the moving speed. However, in the method of Patent Document 1, it is not considered that the excitation light interval changes with time. Since the excitation light is affected by heat generated by the light irradiation unit 104 and the particle sorting system 1 itself, the actual position of the excitation light on the objective lens focal plane is affected by the heat generated by the light irradiation unit 104 and the particle sorting system 1 itself and varies with time. Therefore, if the excitation light interval varies with time after sorting adjustment, it becomes difficult to calculate the optimal charging timing in the conventional technology.

In particular, in a cell sorter having a high-speed sorting processing capability, a liquid column portion L of the jet flow JF tends to be long due to high pressure feeding, and thus, the ratio of the distance from the position of the excitation light to the break-off point BOP where the droplet D is formed to the excitation light spot interval becomes large, and the change in the excitation light spot interval greatly affects the identification of the delay time.

Furthermore, in the cell sorter having a high-speed sorting processing capability, the driving frequency of the vibration element V for forming droplets is high, and in proportion thereto, the accuracy required for the arrival time to the droplet charging position also becomes severe, and the change in the excitation light spot interval greatly affects the identification of the delay time.

In addition, since the particles are detected while flowing through the flow path P, the fluid is ejected as the jet flow JF from the orifice P14 of the flow path P, and then the droplet is charged in the liquid column portion L, the waiting time from the detection to the charging is long, and the delay time is easily affected by the liquid feeding speed. In addition, if the liquid feeding speed changes after the sorting adjustment, the sorting performance is significantly deteriorated.

Therefore, in the present technology, the actual position of the excitation light can be detected by the excitation light detection unit 106, and in the sorting control unit 103, the interval between the plurality of excitation lights can be identified on the basis of the actual position information of the excitation light, and the delay time from the irradiation of the excitation light on the particle to the formation of the droplet containing the particle can be identified on the basis of the identified interval (excitation light interval dₗₐₛₑᵣ) between the plurality of excitation lights. In this way, even when the actual position of the excitation light changes over time, the adjustment accuracy of the delay time can be improved.

In addition, the sorting control unit 103 can determine the velocity of the particle on the basis of the identified interval (excitation light distance dₗₐₛₑᵣ) between the plurality of excitation lights and the detection timing at which the particle is detected by the first detection unit 101, and can identify the delay time on the basis of the velocity of the particle. Therefore, even when the liquid feeding speed changes after sorting adjustment, the adjustment accuracy of the delay time can be improved.

### (9) Excitation Light Control Unit 107

The particle sorting system 1 according to the present technology can include the excitation light control unit 107 that controls the light irradiation unit 104 on the basis of the excitation light information acquired by the excitation light detection unit 106. Specifically, the interval of the excitation light to the particle can be calibrated on the basis of the position information of the plurality of excitation lights acquired by the excitation light detection unit 106, or the optical adjustment of the light irradiation unit 104 can be performed on the basis of the intensity of the excitation light acquired by the excitation light detection unit 106. In addition, the excitation light control unit 107 can also correct the optical signal intensity from the particle detected by the first detection unit 101 on the basis of the intensity change of the excitation light acquired by the excitation light detection unit 106.

Note that in the first embodiment, the excitation light control unit 107 is not essential, but by including the excitation light control unit 107 that controls the light irradiation unit 104, it is possible to prevent the optical information detected by the first detection unit 101 and the delay time calculated by the sorting control unit 103 from being affected by a change in position and a change in intensity of the excitation light emitted from the light irradiation unit 104, and as a result, it is possible to improve detection accuracy and sorting accuracy.

### (10) Light Irradiation Abnormality Detection Unit 108

The particle sorting system 1 according to the present technology can include the light irradiation abnormality detection unit 108 that detects an abnormality of the light irradiation unit 104 on the basis of the intensity of the excitation light acquired by the excitation light detection unit 106. Note that in the present technology, the light irradiation abnormality detection unit 108 is not essential, but by including the light irradiation abnormality detection unit 108 that detects an abnormality of the light irradiation unit 104, for example, in a case where an abnormality of the light irradiation unit 104 is detected by the light irradiation abnormality detection unit 108, optical adjustment of the light irradiation unit 104 can be performed on the basis of the information of the excitation optical detection unit 13, and as a result, the accuracy of particle detection can be improved. In addition, in a case where an abnormal state cannot be avoided even if the optical adjustment of the light irradiation unit 104 is performed on the basis of the information of the excitation light detection unit 106, it is possible to take a measure such as stopping the particle sorting in the sorting unit 105, and as a result, it is possible to avoid unnecessary sorting work.

### (11) Storage Unit 109

The particle sorting system 1 according to the present technology may include the storage unit 109 that stores various data. The storage unit 109 can store all kinds of data related to particle detection and particle sorting, such as optical signal data from a particle detected by the first detection unit 101, excitation light data detected by the excitation light detection unit 106, processing data processed by the sorting control unit 103, excitation light control data controlled by the excitation light control unit 107, abnormality data detected by the light irradiation abnormality detection unit 108, particle sorting data sorted by the sorting unit 105, and the like.

Furthermore, as described above, in the present technology, since the storage unit 109 can be provided in the cloud environment, it is also possible for each user to share the various types of information recorded in the storage unit 109 on the cloud via a network.

Note that in the present technology, the storage unit 109 is not essential, and it is also possible to store the various data using an external storage device and the like.

### (12) Display Unit 110

The particle sorting system 1 according to the present technology may include the display unit 110 that displays various types of information. The display unit 110 can display all kinds of data related to particle detection and particle sorting, such as optical signal data from a particle detected by the first detection unit 101, excitation light data detected by the excitation light detection unit 106, processing data processed by the sorting control unit 103, excitation light control data controlled by the excitation light control unit 107, abnormality data detected by the light irradiation abnormality detection unit 108, particle sorting data sorted by the sorting unit 105, and the like.

In the present technology, the display unit 110 is not essential, and an external display device may be connected. As the display unit 110, for example, a display, a printer and the like may be used.

### (13) User Interface 111

The particle sorting system 1 according to the present technology may include the user interface 111 that is a part operated by the user. The user may access each unit and each device through the user interface 111 to control each unit and each device.

In the present technology, the user interface 111 is not essential, and an external operating device may be connected. As the user interface 111, for example, a mouse, a keyboard and the like may be used.

### 2. Particle Sorting Method

The particle sorting method according to the present technology includes at least a first detection step, a droplet formation step, a second detection step, and a sorting control step. In addition, a sorting step, an excitation light detection step, an excitation light control step, a light irradiation abnormality detection step, a storage step, a display step, and the like can be performed as necessary.

Note that since each step is the same as the step performed by each unit of the particle sorting system 1 according to the present technology described above, the description thereof is herein omitted.

Note that the present technology may also take the following configuration.

(1)

A particle sorting system including:
a first detection unit that detects light from particles contained in a fluid;
a vibration element that forms a droplet containing the particles;
a second detection unit that is arranged downstream of the first detection unit and detects light from the particles in a fluid stream containing the droplet; and
a sorting control unit that controls sorting of the particles on the basis of a delay time from detection by the first detection unit to formation of the droplet; in which
the sorting control unit identifies a parameter used for calculation of the delay time from two or more feature values acquired by the second detection unit using two or more different parameters.
   (2)

The particle sorting system according to (1), in which the feature value is a value measured at two or more different particle velocities.

(3)

The particle sorting system according to (2), in which the feature value is a value identified on the basis of the fluid stream image acquired by the second detection unit.

(4)

The particle sorting system according to (3), in which the feature value is a value related to a position of a particle in the fluid stream image.

(5)

The particle sorting system according to (4), in which the sorting control unit identifies a parameter used for calculation of the delay time from a correspondence relationship between a value related to a position of the particle at each particle velocity and each parameter.

(6)

The particle sorting system according to (4), in which the sorting control unit identifies a parameter used for identifying the delay time from a value related to a deviation width of a position of a particle in the fluid stream image at each particle velocity.

(7)

The particle sorting system according to (3), in which the feature value is a luminance value of a particle in the fluid stream image.

(8)

The particle sorting system according to (7), in which the sorting control unit identifies a parameter used for identifying the delay time from a sum of luminance values of light obtained from particles in the fluid stream image at each particle velocity at an arbitrary position.

(9)

The particle sorting system according to any one of (1) to (8), further including
a light irradiation unit that irradiates the particles with excitation light, and
an excitation light detection unit that includes an imaging element that detects the excitation light with which the particles are irradiated.
   (10)

The particle sorting system according to (9), in which
the light irradiation unit is configured to emit a plurality of excitation lights having different wavelengths at different positions in a flow direction of the fluid, and
the excitation light detection unit detects position information of the plurality of excitation lights.
   (11)

The particle sorting system according to (10), in which the sorting control unit identifies an interval between the plurality of excitation lights on the basis of position information detected by the excitation light detection unit.

(12)

The particle sorting system according to (11), in which the sorting control unit determines a velocity of the particles on the basis of an interval between the plurality of excitation lights and a detection timing at which the particles are detected by the first detection unit.

(13)

A particle sorting method including:
a first detection step of detecting light from particles contained in a fluid;
a droplet formation step of forming a droplet containing the particles;
a second detection step of detecting light from the particles in a fluid stream containing the droplet downstream of the first detection step; and
a sorting control step of controlling sorting of the particles on the basis of a delay time from detection in the first detection step to formation of the droplet, in which
in the sorting control step, a parameter used for calculation of the delay time is identified from two or more feature values acquired in the second detection step using two or more different parameters.

### REFERENCE SIGNS LIST

1 Particle sorting system
10 Particle sorting device
20 Information processing device
P, P11, P12, P13 Flow path
P14 Orifice
104 Light irradiation unit
101 First detection unit
V Vibration element
102 Second detection unit
106 excitation light detection unit
105 Sorting unit
103 Sorting control unit
107 Excitation light control unit
108 Light irradiation abnormality detection unit
109 Storage unit
110 Display unit
111 User interface
105a Charging unit
105b Counter electrode
JF Jet flow
L Liquid column portion
BOP Break-off point
D Droplet
13a, 13b Deflector plate
S Strobe
M Dichroic mirror

1. A particle sorting system comprising:
a first detection unit that detects light from particles contained in a fluid;
a vibration element that forms a droplet containing the particles;
a second detection unit that is arranged downstream of the first detection unit and detects light from the particles in a fluid stream containing the droplet; and
a sorting control unit that controls sorting of the particles on a basis of a delay time from detection by the first detection unit to formation of the droplet; wherein
the sorting control unit identifies a parameter used for calculation of the delay time from two or more feature values acquired by the second detection unit using two or more different parameters.

2. The particle sorting system according to claim 1, wherein the feature value is a value measured at two or more different particle velocities.

3. The particle sorting system according to claim 2, wherein the feature value is a value identified on a basis of the fluid stream image acquired by the second detection unit.

4. The particle sorting system according to claim 3, wherein the feature value is a value related to a position of a particle in the fluid stream image.

5. The particle sorting system according to claim 4, wherein the sorting control unit identifies a parameter used for calculation of the delay time from a correspondence relationship between a value related to a position of the particle at each particle velocity and each parameter.

6. The particle sorting system according to claim 4, wherein the sorting control unit identifies a parameter used for identifying the delay time from a value related to a deviation width of a position of a particle in the fluid stream image at each particle velocity.

7. The particle sorting system according to claim 3, wherein the feature value is a luminance value of a particle in the fluid stream image.

8. The particle sorting system according to claim 7, wherein the sorting control unit identifies a parameter used for identifying the delay time from a sum of luminance values of light obtained from particles in the fluid stream image at each particle velocity at an arbitrary position.

9. The particle sorting system according to claim 1, further comprising
a light irradiation unit that irradiates the particles with excitation light, and
an excitation light detection unit that includes an imaging element that detects the excitation light with which the particles are irradiated.

10. The particle sorting system according to claim 9, wherein
the light irradiation unit is configured to emit a plurality of excitation lights having different wavelengths at different positions in a flow direction of the fluid, and
the excitation light detection unit detects position information of the plurality of excitation lights.

11. The particle sorting system according to claim 10, wherein the sorting control unit identifies an interval between the plurality of excitation lights on a basis of position information detected by the excitation light detection unit.

12. The particle sorting system according to claim 11, wherein the sorting control unit determines a velocity of the particles on a basis of an interval between the plurality of excitation lights and a detection timing at which the particle is detected by the first detection unit.

13. A particle sorting method comprising:
a first detection step of detecting light from particles contained in a fluid;
a droplet formation step of forming a droplet containing the particles;
a second detection step of detecting light from the particles in a fluid stream containing the droplet downstream of the first detection step; and
a sorting control step of controlling sorting of the particles on a basis of a delay time from detection in the first detection step to formation of the droplet, wherein
in the sorting control step, a parameter used for calculation of the delay time is identified from two or more feature values acquired in the second detection step using two or more different parameters.
